(19) United States
(12) Patent Application Publication
(10) Pub. No.: US 2025/0273764 A1
(43) Pub. Date: Aug. 28, 2025

(54) BATTERY MODULE, BATTERY PACK

(71) Applicant: TOYOTA JIDOSHA KABUSHIKI KAISHA, Toyota-shi (JP)

(72) Inventors: Satomi YAMAMOTO, Miyoshi-shi (JP); Yuzo MIURA, Toyota-shi (JP); Yasumasa OGUMA, Toyota-shi (JP); Yusuke KURUMA, Toyota-shi (JP); Hiroaki YAMAMICHI, Takahama-shi (JP); Haruka TSURUTA, Toyota-shi (JP); Takashi GOUDA, Toyota-shi (JP)

(73) Assignee: TOYOTA JIDOSHA KABUSHIKI KAISHA, Toyota-shi (JP)

(21) Appl. No.: 19/041,459

(22) Filed: Jan. 30, 2025

(30) Foreign Application Priority Data
Feb. 22, 2024 (JP) 2024-025438

(51) Int. Cl. H01M 10/6557; H01M 10/613; H01M 10/643; H01M 10/647

(52) U.S. Cl. CPC H01M 10/6557; H01M 10/613; H01M 10/643; H01M 10/647

(57) ABSTRACT

Reduce thermal effects on adjacent battery cells. A first battery cell, a second battery cell adjacent to the first battery cell, and a heat pipe disposed between the first battery cell and the second battery cell and disposed in contact with at least the first battery cell, comprising.

### FIELD

The present disclosure relates to a battery module and a battery pack in which a battery module is enclosed.

### BACKGROUND

Patent Document 1 discloses a battery module comprising a heat spreader sheet and a heat insulating material between a plurality of cells.

### CITATION LIST

### Patent Literature

[Patent Document 1] JP 2022-549926 A

### SUMMARY

### Technical Problem

For example, when one battery cell generates an abnormal heat for some reason, the heat effect on an adjacent battery cell is large, and this heat effect is not preferable for the adjacent battery cell.

In view of the above problems, it is an object of the present disclosure to provide a battery module capable of reducing a heat influence on a battery cell disposed next to each other. Further, a battery pack in which such a battery module is enclosed is provided.

### Solution to Problem

The present application discloses a battery module comprising: a first battery cell; a second battery cell adjacent to the first battery cell; and a heat pipe disposed between the first battery cell and the second battery cell and disposed in contact with at least the first battery cell.

The heat pipe across the first battery cell is disposed on each of one surface and the other surface of the first battery cell, the heat pipe disposed on one surface and the heat pipe disposed on the other surface may be arranged so as to be different positions opposite to each other.

The first battery cell and the second battery cell is a rectangular parallelepiped shape, the heat pipe may be configured as the outer shape is a quadrangular prism shape.

The first battery cell and the second battery cell is a cylindrical shape, the heat pipe may be configured to have a cylindrical shape outer shape.

Also, the present application discloses a battery pack that includes the above-described battery module and a cooler, and the heat pipe of the battery module is directly or connected to the cooler through a heat diffusion plate.

### Advantageous Effects

According to the present disclosure, heat generated in the target battery cell (first battery cell) can be released into the cooler by the heat pipe, so that heat influence on the adjacent battery cell (second battery cell) can be reduced.

### BRIEF DESCRIPTION OF DRAWINGS

FIG. 1 is a perspective view illustrating the configuration of the battery pack 10.

FIG. 2 is a diagram illustrating one battery cell 22 and the heat pipe 24.

FIG. 3 is a perspective view illustrating the configuration of the battery pack 30.

FIG. 4 is a plan view illustrating the configuration of the battery pack 50.

### DESCRIPTION OF EMBODIMENTS

In the following description, the stack comprising a plurality of battery cells are bundled to a battery module, the battery module is sealed by being further stacked plurality is a battery pack.

### 1. Form 1

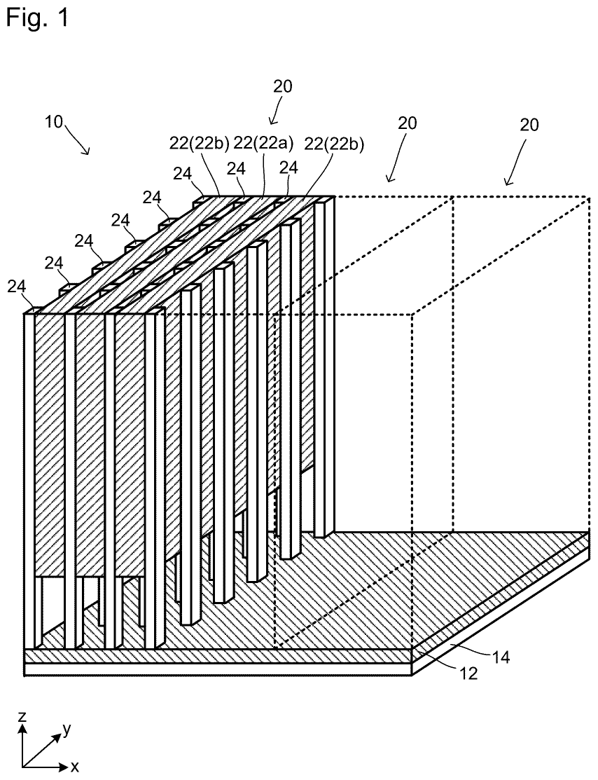

The battery pack 10 including the battery module 20 according to the form 1 in FIG. 1 will be described (outer body for ease of viewing is excluded and represented). It was represented by a perspective view of the appearance. In FIG. 1, a plurality (three in this form) of battery modules 20 are arranged. (Only the battery module 10 on the left of the paper represents a component member, the other two battery modules 10 simply represented only its outer edge in dotted lines.). In the battery module 10 represented on the left side of the page, in order to make it easy to understand another of the member, but not a cross section, it represents a hatching on some of the members. Further, in the figures shown in FIGS. 1 and thereafter, also shown together the direction of the three-dimensional rectangular coordinate system. Here, the x-axis direction is a direction in which the battery cells and battery modules are stacked, the plate surface direction of the battery cells when yz plane is a plate-like. Further, the z-axis is the vertical direction and the larger z is the upper side.

As can be seen from FIG. 1, the battery pack 10 includes a plurality of battery modules 20, a heat diffusion plate 12, and a cooler 14. Further, although not shown, it is provided with a bag-shaped outer package for enclosing and enclosing these.

Hereinafter, each configuration will be described.

### 1.1. Battery Module

As can be seen from FIG. 1, the battery module 20 in this form is configured to have a battery cell 22, and a heat pipe 24.

### [Battery Cell]

Battery cell 22 is a single cell having a flat plate shape as a whole, prismatic, cylindrical or the like appearance (in the present embodiment a flat plate (rectangular parallelepiped) shape), with a side surface having a thickness together with the front and back surfaces in the case of a flat plate It is provided with. The battery cell 22 is as known in the art, and examples thereof include a battery cell using an electrolytic solution and a solid battery using a solid electrolyte in all or a part thereof.

As is known in the art, the battery cell 22 includes a positive electrode and a negative electrode current collector, a positive electrode and a negative electrode active material layer, and a plurality of these are laminated via a separator.

Battery cells 22 in the present embodiment are arranged so as to be adjacent three (the first battery cell 22a, the second battery cell adjacent thereto represented by a battery cell 22b.) The number of battery cells 22 included in the 1 battery module 20 is not particularly limited, and may be 2 or 4 or more.

### [Heat Pipe]

Although the heat pipe 24 is known in the art, for example, a working fluid is sealed in a tubular member which is sealed at both ends. This working fluid receives heat from the heat source (battery cell 22 in this form) evaporates in the tube to become a gas, and moves in the tube to move (diffusion) the heat. As the gas moves or is condensed by being deprived of heat at the transfer destination (the heat diffusion plate 12 in this form) to become a liquid, and the working fluid that has become a liquid returns to the site where the heat source (the battery cell 22 in this embodiment) is disposed. The heat pipe 24 moves (diffusions) the heat by the movement accompanied by the phase change of such working fluid. Incidentally, since the condensate is easily returned to the side serving as a heat source, the fine flow path for the condensate (wick or fine groove) may be provided on the inner surface of the tube.

The operating temperature of the heat pipe 24 can be adjusted by the physical properties of the working fluid. In this form, naphthalene can be used as the working fluid from the viewpoint that the cooling property can be enhanced particularly during abnormal heating by operating the heat pipe 24 in the range of 200° C. to 400° C.

Further, the material constituting the tube of the heat pipe 24 is heat conductivity and strength, it is preferably stainless steel from the viewpoint of the use environment.

The cross-sectional shape of the heat pipe 24 (cross-sectional shape of the tube) is not particularly limited, but rectangular, circular, may be any flat shape. However, since it is preferable that the outer surface of the heat pipe 24 is in contact with the surface of the battery cell 22 in a large area, it is preferable to have a square shape and a flat shape. Since the battery cell 22 in this form is a flat plate (rectangular parallelepiped shape), the heat pipe 24 has its outer shape is a prismatic shape.

### [Structure of Battery Module]

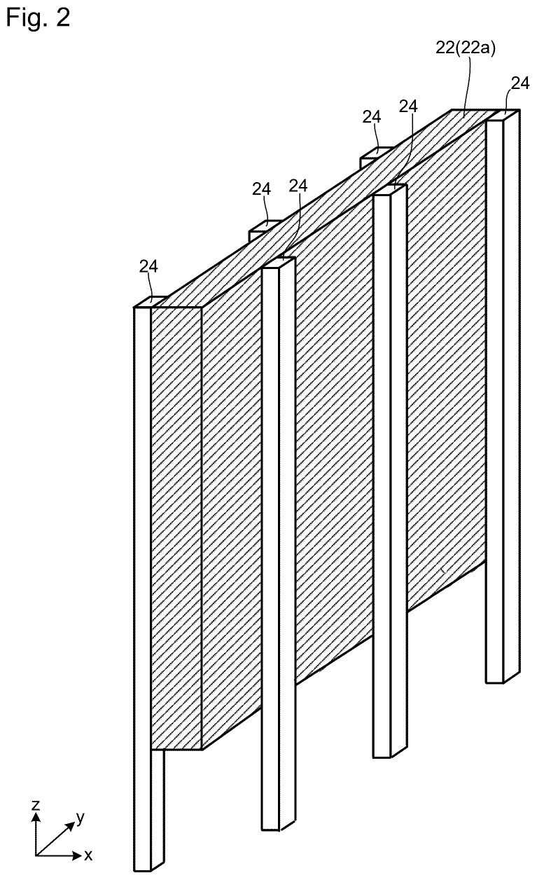

The above-described battery cell 22 and the heat pipe 24 are combined as follows to form a battery module 20. FIG. 2 shows a view in which one battery cell 22 (first battery cell 22a) out of one battery module 20 from FIG. 1 and a heat pipe 24 for cooling the battery cell are extracted.

As can be seen from FIG. 1, the battery module 20 has a plurality of battery cells 22 (the first battery cell 22a, the second battery cell 22b) are arranged in the x-axis direction. As can be seen from FIGS. 1 and 2, for each battery cell 22, a plurality of heat pipes 24 are arranged. Therefore, in the battery module 20, a plurality of heat pipes 24 are provided between the first battery cell 22a and the second battery cell 22b.

Looking at the respective battery cells 22, as shown in FIG. 2, in the present embodiment, three each of the front and back of the battery cell 22 (the first battery cell 22a) (each of the one surface and the other surface across the battery cell 22) heat pipe 24 is disposed.

Each heat pipe 24, the surface of the end side of the one side (evaporation portion side) is disposed so as to contact the surface of the battery cell 22, the other end side (condensing portion side) is the cooler 14 side (z-axis direction in the present embodiment) so as to extend.

The contact portion between the battery cell 22 and the heat pipe 24 can also be brought into contact via a heat transfer paste or the like so that heat is easily transferred. On the other hand, the surface facing the next battery cell 22 (second battery cell 22b) of the heat pipe 24, since it is preferable that the heat of the first battery cell 22a is hardly transferred to the second battery cell 22b, the second battery cell 22b or not in contact with, it may be configured to contact the second battery cell 22b through the heat insulating material.

The plurality of heat pipes 24 are preferably equally spaced with respect to one battery cell 22. Thus it is possible to increase the uniformity of cooling. For example, when the heat pipe 24 on each of the front and back of the battery cell 22 is disposed, the heat pipe 24 of the front and back in plan view (viewed from above in the z-axis direction) may be staggered so as not to overlap the y-axis direction position. That is, the heat pipe 24 disposed on one surface of the battery cell 22 and the heat pipe 24 disposed on the other surface can be arranged so as to be different positions opposite to each other.

### 1.2. Thermal Diffusion Plate

Heat diffusion plate 12 is a plate-shaped member as can be seen from FIG. 1, has a function of widely diffuse heat. Therefore, the heat diffusion plate 12 has a high thermal conductivity can be composed of a material, for example, metal, and specifically, for example, copper, aluminum, stainless steel, and the like.

Further, since the heat diffusing plate 12 preferably has a heat capacity of a certain degree or more, it is preferable to set the thickness thereof to a 1 mm˜2 mm

### 1.3. Cooler

Cooler 14 is a device that eventually releases the heat reached to the outside. Specific forms of the cooler 14 is not particularly limited, for example, it has a cooling plate as a heat exchanger having a water channel through which the cooling water flows, it can be configured to allow heat to escape to the outside through the cooling water by flowing the cooling water here.

### 1.4. Configuration of the Battery Pack

In the battery pack 10 having each of the above configurations, each of the constituent members is combined as follows, for example.

As alternative from FIG. 1, in the battery pack 10, a plurality of battery modules 20 are superimposed in the x-axis direction, in this form extends so that the heat pipe 24 protrudes downward (z-axis direction downward) thereof.

The tip of the protruding heat pipe 24 (the lower end in this form) is made to heat is transferred in contact with the heat diffusion plate 12. To facilitate heat transfer by increasing the contact area between the heat pipe 24 and the heat diffusion plate 12, the end portion of the heat pipe 24 may be bent, or may be through a heat transfer paste or the like.

Of the surface of the heat diffusion plate 12, on the surface opposite to the side where the heat pipe 24 is in contact is arranged so that the cooler 14 is in contact. In order to increase the heat transfer performance, the contact area between the heat diffusion plate 12 and the cooler 14 is better larger, the contact thermal resistance is preferably smaller. Therefore, the heat diffusion plate 12 and the cooler 14 may be superimposed through the heat transfer paste.

Each of the constituent members thus combined is enclosed in a bag-shaped outer package (not shown) to form a battery pack 10.

### 1.5. Effect, etc.

According to the battery module 20 and the battery pack 10 including the same described above, internal short-circuit or the like occurs in a certain battery cell 22, when an abnormal temperature rise occurs, the heat can be discharged to the outside through the heat pipe 24, the battery cells 22 arranged next to the heat effect is reduced, the adjacent battery cells 22 is heated, suppressing the occurrence of chain of abnormal temperature rise, and it is possible to delay the propagation speed even if the chain occurs.

Although in this form the heat diffuser plate 12 and the cooler 14 is disposed below the battery module 20, instead of this, the heat diffuser plate 12 and the cooler 14 may be disposed above the battery module 20 (larger in the z-axis direction). At this time the end of the heat pipe 24 protrudes so as to extend above the battery cell 22, the heat diffusion plate 12 at its tip, further cooler 14 is disposed thereon.

According to this, inside the heat pipe 24, the condensate is easily moved by gravity, since the condensate tends to return to the end portion of the battery cell 22 side which is a heat source, it is possible to increase the transfer efficiency of heat.

Further, in the present embodiment the heat pipe 24 has been connected to the cooler 14 through the heat diffusion plate 12 is not limited thereto, the heat pipe 24 without providing the heat diffusion plate 12 may be brought into contact with the direct cooler 14.

### 2. Form 2

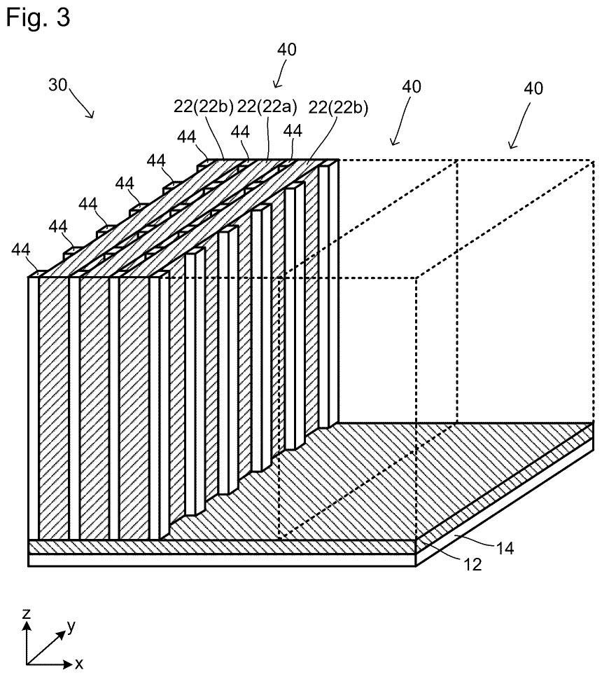

3 describes a battery pack 30 including a battery module 40 according to the form 2 (outer body is represented by excluding.) Shown in perspective view. FIG. 3 is represented in the same view and display mode as in FIG. 1.

In the battery pack 30 is an example in which the battery module 40 is used in place of the battery module 20 of the battery pack 10. Further, in the battery module 40, a heat pipe 44 is applied in place of the heat pipe 24 described above. In other words, in the present embodiment, unlike Form 1 in the heat pipe, the other portions are the same, and therefore, the same reference numerals will be used, and description thereof will be omitted.

In the present embodiment 2, the heat pipe 44 does not protrude from below the battery cell 22, as a result, the surface facing the heat diffusion plate 14 of the surface of the battery cell 22, and the lower end of the heat pipe 44 is disposed so as to contact the heat diffusion plate 14. Such a battery module 40 and a battery pack 30 including the same have the same effects as those of the above-described Embodiment 1.

### 3. Form 3

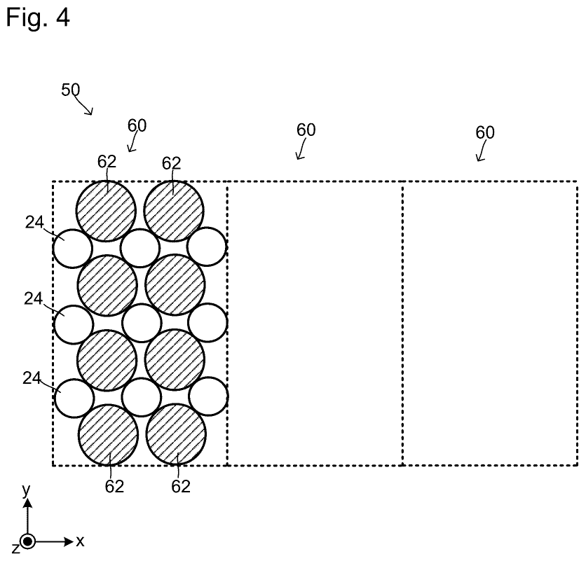

4 describes a battery pack 50 including a battery module 60 according to the form 3 (outer body is represented excluded.) It shows a diagram. FIG. 4 is appeared in the same manner as in FIG. 1, the viewpoint is a view of the battery pack 50 from above in the z-axis direction (plan view).

In the battery module 60 according to the form 3, a cylindrical battery cell 62 is used, the heat pipe 24 is disposed so as to contact these battery cells 62 between the adjacent battery cells 62. Therefore, the heat pipe 24 of the present embodiment has its outer shape is a cylindrical shape, the outer peripheral surface is configured to contact with the outer peripheral surface of the cylindrical battery cell 62.

Other than this, it can be considered in the same manner as in the above-described Form 1 and Form 2, and the battery module 60 and the battery pack 50 including the same have the same effects as those of the above-described Form 1

### REFERENCE SIGNS LIST

10, 30, 50 . . . Battery pack, 12 . . . thermal diffuser, 14 . . . cooler, 20, 40, 60 . . . battery module, 22 . . . battery cell, 24 . . . heat pipe

What is claimed is:

1. A battery module comprising:
a first cell;
a second cell adjacent to the first cell; and
heat pipes disposed between the first and second cells in contact with at least the first cell.

2. The battery module according to claim 1, wherein
at least one of the heat pipes is disposed on one side of the first cell and rest of the heat pipes are disposed on another side of the first cell with the first cell between said at least one heat pipe and the rest, and
the rest are located on different positions from said at least one heat pipe on an opposite side of the first cell.

3. The battery module according to claim 1, wherein
the first and second cells have rectangular parallelepiped shapes, and
the heat pipes have outer shapes of quadrangular prisms.

4. The battery module according to claim 1, wherein
the first and second cells have cylindrical shapes, and
the heat pipes have cylindrical outer shapes.

5. A battery pack comprising:
the battery module according to claim 1; and
a cooler, wherein
the heat pipes of the battery module are connected to the cooler directly or via a heat diffusion plate.
